(19) United States
(12) Patent Application Publication
(10) Pub. No.: US 2026/0155765 A1
(43) Pub. Date: Jun. 4, 2026

(54) SYSTEMS AND METHODS FOR SENSORLESS CONTROL OF A MOTOR

(71) Applicant: Mitsubishi Electric Research Laboratories, Inc., Cambridge, MA (US)

(72) Inventors: Yebin Wang, Cambridge, MA (US); Jingjie Wu, Madison, WI (US)

(73) Assignee: Mitsubishi Electric Research Laboratories, Inc., Cambridge, MA (US)

(21) Appl. No.: 18/991,829

(22) Filed: Dec. 23, 2024

Related U.S. Application Data
(60) Provisional application No. 63/726,422, filed on Nov. 29, 2024.

(51) Int. Cl. H02P 21/09; H02P 21/18; H02P 21/22

(52) U.S. Cl. CPC H02P 21/09; H02P 21/18; H02P 21/22; H02P 2203/05; H02P 2207/01

(57) ABSTRACT

System and method for sensorless control of an induction motor are disclosed. A flux observer estimates a rotor flux based on stator voltage and current measurement. A low frequency signal injection module generates a flux estimation error signal at low motor speed, while a baseline observer generates a model based flux estimation error signal at medium to high motor speed. A switching mechanism selects between these error signal based on motor condition. A proportional integral regulator and integrator process the selected error signal to estimate rotor speed. A lead compensator adjusts phase during transitions to ensure stability, with a switching signal generator activating the LFSI module when stator frequency falls below a predefined threshold. This control system provides rotor flux and speed estimation across a full range of motor speed by adaptively switching between observers based on operating conditions.

### TECHNICAL FIELD

The present disclosure relates generally to control systems for electric motors and more particularly to systems and methods for controlling the speed or torque of induction motors without using sensors for measuring the speed or the position of the motor.

### BACKGROUND

Induction motors with variable speed and torque are widely used due to their low maintenance costs and reliable performance. However, controlling these motors poses challenges because of their inherent nonlinear dynamics. Vector control, also known as field-oriented control (FOC), is a common approach for managing induction motors. In FOC, the stator currents of a three phase AC electric motor are represented as two orthogonal components, allowing one component to align with the rotor magnetic flux while the other influences the electromagnetic torque. The control system, often incorporating proportional integral (PI) controllers, manages these components to maintain desired flux and torque levels.

Sensorless control methods eliminate the need for physical speed sensors, which reduces costs and enhances system reliability. These motor drive systems and motors are sensorless in that they do not include functionality to measure the voltage feedback from the motor and/or sensors to detect the position of the motor rotor. Rather, rotor position is determined based on estimates of the motor winding currents. A significant aspect of sensorless control is estimating rotor speed without direct measurement. Existing sensorless control approaches primarily fall into two categories: model-based methods and signal injection approaches. The model-based methods use dynamic equations to infer rotor speed from current measurements, enabling control without additional hardware. Examples include voltage model-based integration, adaptive observers, and extended Kalman filters. However, these approaches fail at low speeds or near zero frequencies, as the motor dynamics become less inferable, leading to reduced accuracy in rotor speed estimation.

To address these limitations, frequency signal injection (FI) methods have been developed. One such method is the high frequency signal injection (HFI) technique. HFI based techniques rely on motor saliency, or structural asymmetry, to enhance observability of rotor speed at low frequencies. Another approach in this regard are the low frequency signal injection (LFI) methods. LFI methods induce periodic pulsation in rotor speed, which in turn modulates the measured current signal through motor saliency, making it suitable for wider range of motors at light loads.

While LFI provides improved controls at low speeds, baseline model-based control is more effective in medium and high-speed regions. Despite their complementary strengths, there is currently no effective switching mechanism to integrate the methods for sensorless operation across the full speed range. Accordingly, there is a need for control systems and methods that integrate FI (including HFI and LFI) and baseline model-based methods, enabling smooth transition between control modes and robust performance across a wide range of operating conditions.

### SUMMARY

Accordingly, it is an objective of some embodiments to enable robust control of an induction motor across a full range of operational speed, including near zero speeds, while providing smooth transitions between different control methodologies. Some embodiments are based on the recognition that conventional model-based approaches face stability challenges at low speed or near zero frequency, while frequency injection (FI) methods, typically used in these regions, lack smooth integration with model-based control.

To address this, various embodiments incorporate a dynamic switching mechanism that leverages the time derivative of the estimated rotor speed, facilitating a smooth transition between FI-based control and fundamental model-based control. An auxiliary signal is used to ensure stability across transitions, allowing operation over the full speed and torque range of the motor.

As used with the description of various embodiments, low-frequency motor operation refers to the use of electric motors at lower speeds or frequencies than their standard rated operating frequency. Such operations are desired in applications where the motor needs to operate at reduced speeds, variable speeds, or with extended torque characteristics. Some non-limiting examples of such applications include motors used in applications such as conveyors, Heating, ventilation and air conditioning (HVAC) systems, pumps, fans, and other machinery requiring adjustable speeds. As used with the description of various embodiments, high-frequency motor operation refers to the use of electric motors at higher-than-normal or rated operating frequencies, typically resulting in higher speeds. High-frequency operation is commonly used in applications that require fast motor speeds. These may include machine tools (e.g., spindles for drilling or milling), centrifugal compressors, high-speed fans, and electric vehicles.

Further, some embodiments introduce an adaptive estimation technique. During low frequency operation, a frequency signal injection is applied to the rotor speed signal to enhance stability, while for the higher frequency operation, a model-based estimator is employed. The disclosed approach computes the rotor flux angle using a unified formula across both control methods, ensuring consistent rotor angle estimation and rotor speed estimation.

Additionally, some embodiments operate the model-based estimator in parallel with the LFI based estimator, where the LFI based estimated angular speed data is provided to the model-based estimator at low speed to reduce transient error during control transition. Such a parallel configuration facilitates real time correction of the model-based estimator during the transition to the LFI based control. Moreover, some embodiments provide a unique LFI method for rotor speed estimation, specifically optimized for seamless integration with the model-based method.

Accordingly, one embodiment discloses a control system for sensorless control of an induction motor. The control system comprises a low-frequency signal injection (LFSI) module configured to inject a pulsating current along a reference axis of the induction motor to generate a flux estimation error signal at low speeds of the induction motor. The control system also comprises a baseline observer configured to generate a model-based flux estimation error signal at medium-to-high speeds of the induction motor, based on dynamic equations of the induction motor. A switching mechanism of the control system is configured to select between the LFSI-based flux estimation error signal and the model-based flux estimation error signal based on a switching signal generated by a switching signal generator. The switching signal generator is configured to monitor an estimated stator frequency of the motor and activate the LFSI module through the switching mechanism when the stator frequency falls below a predefined threshold. The control system also comprises a proportional-integral (PI) regulator configured to receive the selected flux estimation error signal to estimate a rotor speed derivative, and an integrator coupled to the PI regulator. The integrator is configured to integrate the rotor speed derivative estimate to obtain a rotor speed estimate. The control system further comprises a controller configured to generate control commands for controlling the motor, based on the rotor speed estimate.

In yet another example embodiment, a computer-implemented method for controlling an induction motor is provided. The method comprises collecting stator frequency data of the motor and generating a switching signal based on the stator frequency data. The method further comprises activating a low-frequency signal injection (LFSI) module based on the stator frequency of the motor being less than or equal to a threshold and activating a baseline observer based on the stator frequency of the motor being greater than the threshold. The LFSI module is configured to inject a pulsating current along a reference axis of the induction motor to generate a flux estimation error signal at low speeds of the induction motor. The baseline observer is configured to generate a model-based flux estimation error signal at medium-to-high speeds of the induction motor, based on dynamic equations of the induction motor. The method further comprises selecting between the LFSI-based flux estimation error signal and the model-based flux estimation error signal based on the switching signal. The method further comprises estimating a rotor speed derivative, based on the selected flux estimation error signal and integrating the rotor speed derivative estimate to obtain a rotor speed estimate. The method further comprises generating control commands for controlling the motor, based on the rotor speed estimate.

In yet another example embodiment, a drive control method for operating an induction machine at torque control mode is provided. The drive control method comprises collecting a temporal profile of a preferred torque for the induction machine, a first estimate of rotor flux angle, and a first estimate of rotor speed of the induction machine. The method further comprises determining d-axis current reference and q-axis current reference for the induction machine, based on the first estimate of rotor flux angle and the first estimate of rotor speed. The method further comprises generating an injection signal based on the first estimate of rotor speed and obtaining d-axis current measurement and q-axis current measurement for the induction machine. The method further comprises generating a d-axis error signal based on the d-axis current reference and the d-axis current measurement and generating a q-axis error signal based on the q-axis current reference and the q-axis current measurement. The method further comprises generating a d-axis reference voltage based on the d-axis error signal and the injection signal and generating a q-axis reference voltage based on the q-axis error signal. The method further comprises generating a three-phase voltage reference from the d-axis reference voltage and q-axis reference voltage, based on an inverse Clarke/Park transformation. The method further comprises controlling the induction machine based on the three-phase voltage reference.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of a control system for sensorless control of an induction motor, according to some embodiments;

FIG. 1B illustrates a flowchart of a method for sensorless control of an induction motor, according to some embodiments;

FIG. 2A illustrates a block diagram of a motion control system, according to some embodiments;

FIG. 2B illustrates a schematic of an inverter of the motion control system of FIG. 2A, according to some embodiments;

FIG. 2C illustrates a coordinate and vector diagram of an induction motor, according to some embodiments;

FIG. 3A illustrates schematics of a drive controller for operating an induction machine at torque control mode, according to some embodiments;

FIG. 3B illustrates a flowchart of a method performed by the drive controller of FIG. 3A, according to some embodiments;

FIG. 4 illustrates a block diagram of an integrated state estimator of the drive controller of FIG. 3A, according to some embodiments;

FIG. 5 illustrates a block diagram of a high-frequency signal processing module of the integrated state estimator of FIG. 4, according to some embodiments; and

FIG. 6 illustrates some components of a system for controlling a motor, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

### Overview

Induction motors find use in various industry systems owing to their simple construction, low cost and low maintenance requirements. For high-performance applications, indirect field-oriented control (IFOC) is utilized to achieve high dynamic performance and wide speed operation. Typically, a sensor such as encoder and Hall sensor is required to obtain the rotor speed and thus estimate the rotor flux angle to enable IFOC implementation. However, the inclusion of a speed sensor introduces and leads to several challenges. For example, the use of a sensor increases the system's cost and size, reduces overall reliability, and may not be suitable for installation in harsh environments. Furthermore, the reading provided by such sensors is always subject to error due to structural, operational, and environmental factors. As such, sensor-based approaches for estimating rotor speed and thus estimating the rotor flux are not suitable for precision and mission critical applications. It is a realization of various example embodiments that speed sensorless control for induction motors is a potential feasible solution to the aforementioned problems.

Some example embodiments realize that most sensorless techniques currently under investigation can be classified into two main groups: model-based approaches and signal-injection-based approaches. In the model-based method, rotor flux angle and speed are estimated based on the standard voltage model or full-order flux observer. On the other hand, the signal-injection-based method employs a test injection signal to exploit the machine's anisotropic properties such as inductance saturation and slot harmonics, to provide useful information of field angle or rotor position. Through comparative demonstration and experimentation, some embodiments recognized that while the model-based approaches demonstrate a decent performance in medium-to-high speed operations, they cannot maintain stability in zero or low-speed range due to its inherent lack of observability. It is also a realization of some embodiments that signal injection-based methods are effective for sensorless control at low speed but are not suitable in mid-to-high speed range as the increasing back-EMF degrades the signal-to-noise ratio (SNR). For machines without spatial saliency, the low-frequency signal injection (LFSI) method provides an alternative for detecting the flux angle by analyzing the response to speed perturbations.

Various embodiments are based on the realization that an individual approach cannot achieve full speed range sensorless control required in many applications. To address this challenge, there have been attempts to improve the stability of model-based approach at zero or low frequency. However, these attempted solutions still suffer from the fundamental limit of model-based observer that is sensitive to parameter mismatch and cannot operate for a long time especially at low frequency. Even with solutions that combine the estimated speed from a model-based observer and high-frequency injection-based observer, the stability of the combination is not guaranteed, the transitions are not smooth and discontinuous, and the tuning of weighting parameters requires significant efforts.

In order to overcome the aforementioned challenges and thus achieve smooth speed-sensorless drive control at full speed range, some example embodiments provide a novel unified observer combining a modified LFSI observer and adaptive full-order (AFO) flux observer in rotor flux reference frame for induction machine without saliency. The error signals obtained from modified LFSI and AFO observers are switched based on a switching signal indicating the observability of the system, which guarantees the stability over all operating conditions. The switched error signal is then used to compute the derivative of estimated rotor speed through a PI controller so that the speed estimation after an additional integration is always smooth. The LFSI observer part is modified in comparison to its counterparts to enable the switching on the speed derivative rather than speed itself in conventional way. A thorough theoretical analysis for LFSI stability and controller design are illustrated.

### Motor Control System and Method

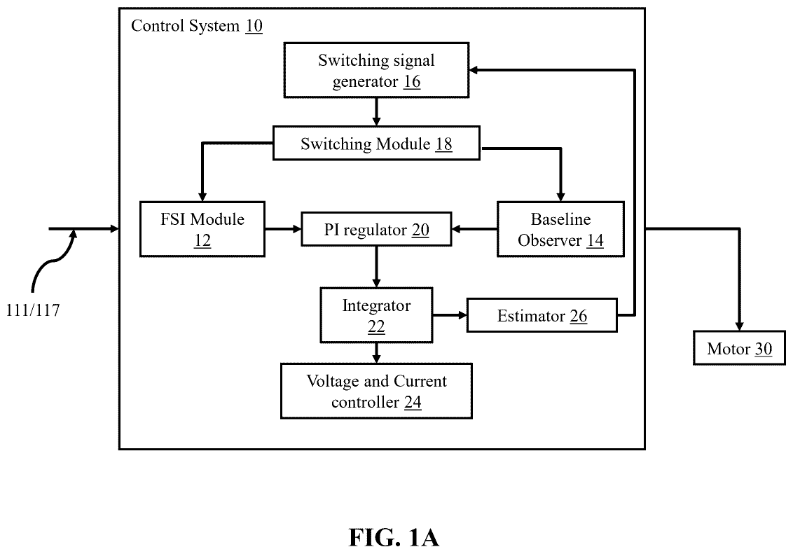

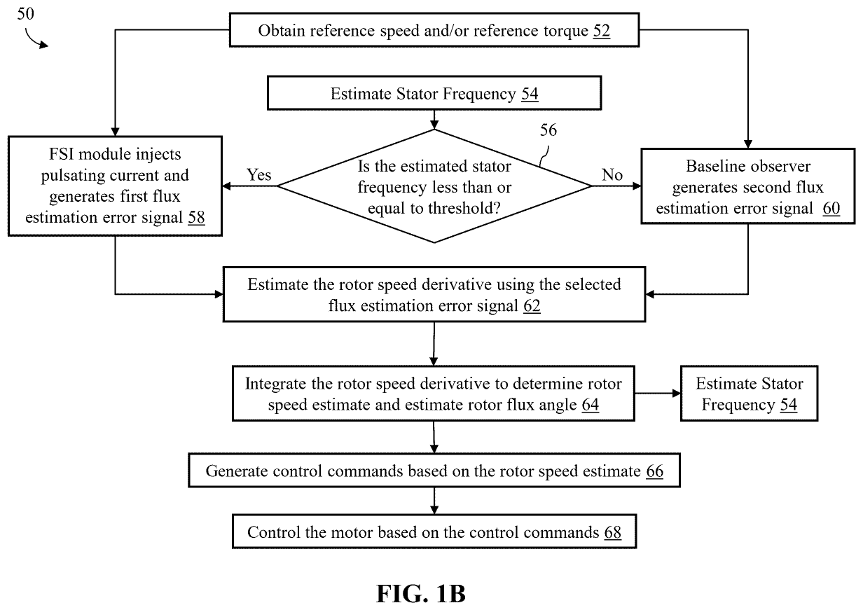

FIG. 1A illustrates a block diagram of a control system 10 for sensorless control of an induction motor 30, according to some embodiments. The control system 10 may be operatively and communicatively coupled to one or more other components such as one or more databases, a motion controller and the like. In some embodiments, the motion controller may receive input commands from a user or other computer program and compute reference values for the torque and speed of the motor 30. Specifically, the motion controller may generate a torque reference signal 111 defining a target torque that the motor 107 should produce. Additionally, or alternately, the motion controller may generate a speed reference signal 117 specifying a desired rotor speed. The reference signal(s) 111/117 may be computed by the motion controller based on the requirement of the application and the load being driven by the motor 30.

The control system 10 comprises a frequency signal injection (FSI) module 12, a baseline observer 14, a switching signal generator 16, a switching module 18, a proportional-integral (PI) regulator 20, an integrator 22, and a voltage and current controller 24. The FSI module 12 is configured to inject a pulsating current along a reference axis of the induction motor 30 to generate an FSI-based flux estimation error signal (also referred to as a first flux estimation error signal) at low speeds of the induction motor. According to some embodiments, the FSI module 12 may be a low-frequency signal injection module. Alternately, in some embodiments, the FSI module 12 may be a high-frequency signal injection module. The baseline observer 14 uses a fundamental model-based method to generate a model-based flux estimation error signal (also referred to as a second flux estimation error signal) at medium-to-high speeds of the induction motor, using dynamic equations of the induction motor. In this regard, the dynamic equations of the induction motor may be obtained from a model of dynamics of the motor that may be stored in a memory. The switching mechanism/module 18 of the control system is configured to select between the FSI-based flux estimation error signal and the model-based flux estimation error signal based on a switching signal generated by a switching signal generator 16. In this regard, the switching signal generator 16 is configured to monitor a stator frequency of the motor 30 and activate the FSI module 12 through the switching mechanism/module 18 when the stator frequency falls below a predefined threshold. The value of the threshold may be configurable/tunable as per load and application requirements. The PI regulator 20 receives the selected flux estimation error signal (generated either by the FSI module 12 or the baseline observer 14) to estimate a rotor speed derivative for the motor 30. The integrator 22 may be coupled to the PI regulator 20 and is configured to integrate the rotor speed derivative estimate over time to obtain a rotor speed estimate. The estimator 26 may estimate the stator frequency from the rotor speed estimate. The controller 24 is configured to generate control commands for controlling the motor 30, based on the rotor speed estimate. For example, the controller 24 may generate voltages and currents for operating the motor 30. Some or all of the components of the control system 10 may be realized in electronic circuitry commonly known in the art. Also, in some embodiments, the control system 10 may comprise fewer or more components than shown in FIG. 1A without deviating from the scope of this disclosure. Additionally, one or more components of the control system 10 may be broken down into sub-systems,

FIG. 1B illustrates a flowchart of a method 50 for sensorless control of the induction motor 30, according to some embodiments. FIG. 1B will be described with reference to one or more elements from FIG. 1A. The reference speed and/or torque may be obtained 52 in the manner as discussed with respect to reference signals 111 and 117 of FIG. 1A. The switching signal generator 16 is configured to monitor an estimated stator frequency of the motor 30. In this regard, the stator frequency may be estimated 54 from the rotor speed estimate and compared with a threshold. At step 56, the estimated stator frequency is compared with the threshold to check if the stator frequency is less than or equal to the threshold. If the check at step 56 is positive, the control of steps passes to step 58 and the FSI module is activated to inject a pulsating current and a first flux estimation error signal (also referred to as an FSI-based flux estimation error signal) is generated. However, if the check at step 56 returns a negative, the method 50 proceeds to step 60 where the baseline observer generates a second flux estimation error signal (also referred to as a model-based flux estimation error signal). Therefore, the switching signal generator, in effect, switches between the first flux estimation error signal and the second flux estimation error signal, based on the estimated stator frequency. As an outcome, one of the first flux estimation error signal or the second flux estimation error signal is output as a selected flux estimation error signal.

The selected flux estimation error signal is utilized to estimate 62 the rotor speed derivative by the PI regulator 20 while the integrator 22 integrates the rotor speed derivative estimate to determine 64 a rotor speed estimate from which the rotor flux angle is estimated. The stator frequency is estimated 54 from the rotor speed estimate. Further processing is performed using the estimated rotor speed estimate to generate 66 control commands for the motor 30. For example, the estimated rotor flux angle may be utilized for performing inverse Clarke/Park transformation which is described later in this disclosure. The control commands may specify values and phases of voltages and currents provided to the motor 30. The motor is thereafter controlled 68 in accordance with the control commands.

### Operations and Models

The operational and modelling aspects of motor control are now described in detail. However, it may be contemplated the description is only exemplary and should not be considered as limiting for the disclosed embodiments.

Let ζ denote a variable, ζ̅ as the measured variable, \hat{ζ} as the estimate of the variable, ζ* as the reference of the variable, \tilde{ζ}=ζ−\hat{ζ} as the estimation error, e_{ζ}=ζ*−ζ as the tracking error, and ζ^{h} denote the high frequency component of ζ. If there are no measurement noises, then the measured variable ζ̅=ζ. Space vectors in a stationary reference frame are denoted by subscript αβ, whereas space vectors in a synchronous dq reference frame are denoted by subscript dq. The quantities corresponding to motor stator are denoted by the subscript s while the rotor by r. Real space vectors are used; for example, the stator current is i_{dqs}=[i_{ds} i_{qs}]^{T} where i_{ds} and i_{qs} are the vector components in the synchronous dq reference frame. The orthogonal rotational matrix is

$$J = [ \begin{matrix}0 & - 1 \\ 1 & 0\end{matrix} ]$$

and I is the identity matrix. Some notations are given in Table 1 below:

### Notations

| Notation | Description |
|---|---|
| λₛ | stator flux vector |
| λᵣ | rotor flux vector |
| iₛ | stator current vector |
| iᵣ | rotor current vector |
| uₛ | stator voltage vector |
| λ_{ds}, λ_{qs} | stator fluxes in d- and q-axis |
| λ_{dr}, λ_{qr} | rotor fluxes in d- and q-axis |
| i_{ds}, i_{qs} | stator currents in d- and q-axis |
| u_{ds}, u_{qs} | stator voltages in d- and q-axis |
| ω₀ | angular speed of a rotating frame |
| ωₛ | synchronous stator electrical speed |
| ωᵣ | rotor electrical angular speed |
| ωₛₗᵢₚ | slip angular speed |
| ρ | rotor flux field angle |
| θ | angle of a rotating frame |
| Tₑ | electric torque |
| Tₗ | load torque |
| T* | torque reference |
| ${i}_{ds}^{*} , {i}_{qs}^{*}$ | references of stator currents in d- and q-axis |
| p | number of pole pairs |
| Rₛ, Rᵣ | stator and rotor resistances |
| Lₛ, Lₘ, Lᵣ | stator, mutual, and rotor inductances |
| σ | $leakage factor , \frac{{L}_{s} {L}_{r} - {L}_{m}^{2}}{{L}_{s} {L}_{r}}$ |
| α | Rᵣ/Lᵣ |
| β | Lₘ/Lᵣ × 1/(Lₛσ) |
| γ | Rₛ/(Lₛσ) + αßLₘ |
| J | rotor inertia |

### Mathematical Model of an Induction Machine

Electromagnetic Model: In the dq reference frame rotating at a speed ωₛ, the voltage equations of an induction machine are expressed as:

$$\frac{d {λ}_{dqs}}{dt} = {v}_{dqs} - {R}_{s} {i}_{dqs} - {ω}_{s} J {λ}_{dqs} \qquad ( 1 a )$$

$$\frac{d {λ}_{dqr}}{dt} = - {R}_{r} {i}_{dqr} - ( {ω}_{s} - {ω}_{r} ) J {λ}_{dqr} \qquad ( 1 b )$$

where λ_{dqs} and λ_{dqr} are the stator and rotor flux linkages, respectively. The current-model equations of the stator and rotor fluxes are as follows:

$${λ}_{dqs} = {L}_{s} {i}_{dqs} + {L}_{m} {i}_{dqr} \qquad ( 2 )$$

$${λ}_{dqr} = {L}_{m} {i}_{dqs} + {L}_{r} {i}_{dqr}$$

The electromagnetic torque is given by:

$${T}_{e} = \frac{3 p}{2} {i}_{dqs}^{T} J {λ}_{dqs} = \frac{3 p}{2} \frac{{L}_{m}}{{L}_{r}} {λ}_{dr} {i}_{qs} \approx \frac{3 p}{2} {λ}_{dr} {i}_{qs} \qquad ( 3 )$$

From (2), i_{dqr} may be obtained as:

$${i}_{dqr} = \frac{1}{{L}_{r}} ( {λ}_{dqr} - {L}_{m} {i}_{dqs} ) \qquad ( 4 )$$

Substituting (4) into (1b) yields:

$$\frac{d {λ}_{dr}}{dt} = - a {λ}_{dqr} - ( {ω}_{s} - {ω}_{r} ) J {λ}_{dqr} + a {L}_{m} {i}_{dqs}$$

The speed of the rotor flux-oriented reference frame (rotating at a speed ωₛ such that λ_{qr}=0 and i_{qr}=0) is given by

$${ω}_{s} = {ω}_{r} + \frac{{L}_{m} {i}_{qs}}{{τ}_{s} {λ}_{dr}}$$

where the second term in the sum is ωₛₗᵢₚ.

The rotor flux dynamics are simplified to:

$$\frac{d {λ}_{dr}}{dt} = - a {λ}_{dr} + a {L}_{m} {i}_{ds} \qquad ( 5 )$$

State-Space Representations: In a reference dq frame rotating at an angular speed ω₀, the induction machine model, combining (1a), (1b), and (2), is given by:

$$\frac{d {λ}_{s}}{dt} = - ( {a}_{11} - j {ω}_{0} ) {λ}_{s} + {a}_{12} {λ}_{r} + {v}_{s} , \qquad ( 6 )$$

$$\frac{d {λ}_{r}}{dt} = {a}_{21} {λ}_{s} + ( {a}_{22} + j ( {ω}_{r} - {ω}_{0} ) ) {λ}_{r} ,$$

$$\frac{d {ω}_{r}}{dt} = \frac{p}{J} ( {T}_{e} - {T}_{l} ) ,$$

$${T}_{e} = \frac{3 p}{2} {L}_{m} Im [ {c}_{11} {c}_{22} {λ}_{s} {λ}_{r}^{*} + {c}_{12} {c}_{21} {λ}_{r} {λ}_{s}^{*} ]$$

$${i}_{s} = {c}_{11} {λ}_{s} + {c}_{12} {λ}_{r} ,$$

where superscript * denotes the conjugate operator, and

$${a}_{11} = \frac{- {R}_{s}}{{L}_{s} {σ}^{′}} , {a}_{12} = \frac{{L}_{m} {R}_{s}}{{L}_{r} {L}_{s} σ}$$

$${a}_{21} = \frac{{L}_{m} {R}_{r}}{{L}_{r} {L}_{s} {σ}^{′}} , {a}_{22} = \frac{- {R}_{r}}{{L}_{r} σ}$$

$${c}_{11} = \frac{{L}_{r}}{{L}_{s} {L}_{r} - {L}_{M}^{2}} = \frac{1}{{L}_{s} σ} , {c}_{12} = \frac{- {L}_{m}}{{L}_{s} {L}_{r} - {L}_{M}^{2}} = - \frac{{L}_{m}}{{L}_{r} {L}_{s} σ}$$

$${c}_{21} = {c}_{12} , {c}_{22} = \frac{{L}_{s}}{{L}_{s} {L}_{r} - {L}_{M}^{2}} = \frac{1}{{L}_{r} σ}$$

In the rotor flux field-oriented frame, (6) can be written as follows:

$$[ \begin{matrix}{\dot{λ}}_{ds} \\ {\dot{λ}}_{qs} \\ {\dot{λ}}_{dr}\end{matrix} ] = \underbrace{[ \begin{matrix}{a}_{11} & {ω}_{0} & {a}_{12} \\ - {ω}_{0} & {a}_{11} & 0 \\ {a}_{21} & 0 & {a}_{22}\end{matrix} ]} [ \begin{matrix}{λ}_{ds} \\ {λ}_{qs} \\ {λ}_{dr}\end{matrix} ] + \underbrace{[ \begin{matrix}1 & 0 \\ 0 & 1 \\ 0 & 0\end{matrix} ]} {v}_{dqs} \qquad ( 7 )$$

$${\dot{ω}}_{r} = \frac{p}{j} ( {T}_{e} - {T}_{i} )$$

$$\dot{p} = {ω}_{0} ,$$

$$y = [ \begin{matrix}{c}_{11} & 0 & {c}_{12} \\ 0 & {c}_{11} & 0\end{matrix} ] [ \begin{matrix}{λ}_{ds} \\ {λ}_{qs} \\ {λ}_{dr}\end{matrix} ]$$

$${T}_{e} = {μλ}_{qs} {λ}_{dr}$$

$$μ = \frac{3 p}{2} {L}_{m} ( {c}_{11} {c}_{22} - {c}_{12} {c}_{21} ) ,$$

where ω₀ is solved from \dot{λ}_{qr}=λ_{qr}=0 as:

$${ω}_{0} = {ω}_{r} + {ω}_{slip} = {ω}_{r} + \frac{{a}_{21} {λ}_{qs}}{{λ}_{dr}} = {ω}_{s} .$$

The induction machine model may also be represented in the state coordinates

$${[ {i}_{s}^{T} , {λ}_{r}^{T} , {ω}_{r} ]}^{T} .$$

The corresponding model in the frame rotating at an angular speed ω₀ is given by:

$${\dot{i}}_{ds} = - γ {i}_{ds} + {ω}_{0} {i}_{qs} + β ( {αλ}_{dr} + {ω}_{r} {λ}_{qr} ) + \frac{{v}_{ds}}{{L}_{s} σ} \qquad ( 8 )$$

$${\dot{i}}_{qs} = - {ω}_{0} {i}_{ds} - γ {i}_{qs} + β ( {αλ}_{qr} - {ω}_{r} {λ}_{dr} ) + \frac{{v}_{qs}}{{L}_{s} σ}$$

$${\dot{λ}}_{dr} = - {αλ}_{dr} + ( {ω}_{0} - {ω}_{r} ) {λ}_{qr} + α {L}_{m} {i}_{ds}$$

$${\dot{λ}}_{qr} = - {αλ}_{qr} + ( {ω}_{0} - {ω}_{r} ) {λ}_{dr} + α {L}_{m} {i}_{qs}$$

$${\dot{ω}}_{r} = \frac{1}{J} ( \frac{3 {pL}_{m}}{2 {L}_{r}} ( {λ}_{dr} {i}_{qs} - {λ}_{qr} {i}_{ds} ) - {T}_{l} )$$

$$y = [ \begin{matrix}{i}_{ds} & {{i}_{qs} ]}^{T} .\end{matrix}$$

When ω₀=ωₛ, then we have

$${\dot{i}}_{ds} = - γ {i}_{ds} + {ω}_{s} {i}_{qs} + {βαλ}_{dr} + \frac{{v}_{ds}}{{L}_{s} σ} \qquad ( 9 )$$

$${\dot{i}}_{qs} = - {ω}_{s} {i}_{ds} - γ {i}_{qs} + {βω}_{r} {λ}_{dr} + \frac{{v}_{qs}}{{L}_{s} σ}$$

$${\dot{λ}}_{dr} = - {αλ}_{dr} + α {L}_{m} {i}_{ds}$$

$${\dot{ω}}_{r} = \frac{p}{J} ( \frac{3 {pL}_{m}}{2 {L}_{r}} {λ}_{dr} {i}_{qs} - {T}_{l} )$$

$$y = [ \begin{matrix}{i}_{ds} & {{i}_{qs} ]}^{T} .\end{matrix}$$

Denote x=[i_{ds}, i_{qs}, λ_{dr}]^{T}.

Back-EMF: From (8), the back-EMF (i.e., the electromagnetic force induced from the rotor flux) can be readily obtained as follows:

$${v}_{back - EMF} = \frac{{L}_{m}}{{L}_{r}} [ \begin{matrix}- {αλ}_{dr} \\ {ω}_{r} {λ}_{dr}\end{matrix} ] .$$

### Motion Control System

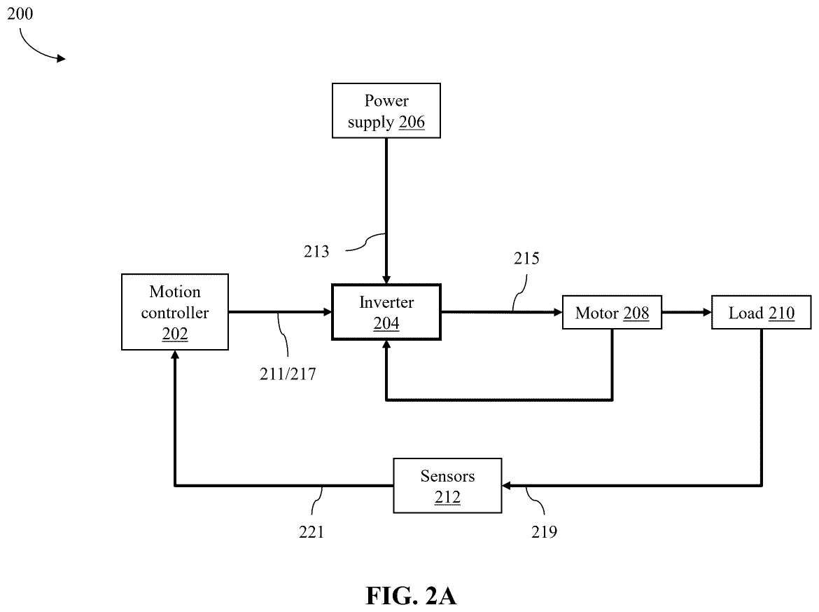

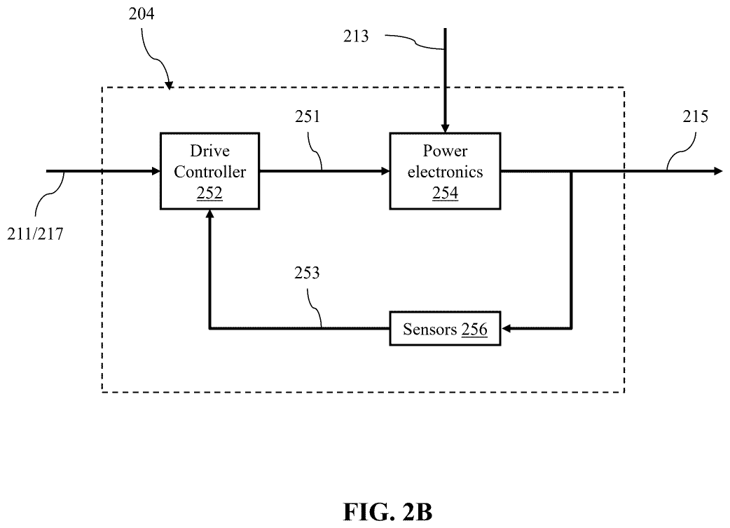

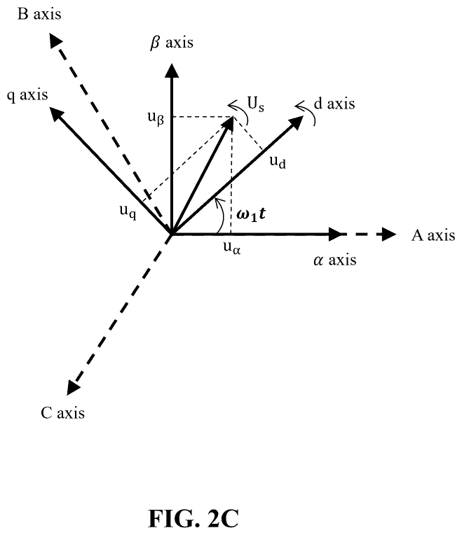

FIG. 2A illustrates a block diagram of a motion control system 200, according to some embodiments. The motion control system 200 is configured to control an electric motor 208, which serves as a torque actuator to drive a load 210, in accordance with some embodiments of the disclosure. The system 200 is designed to provide precise control over the motor torque and speed by leveraging both a motion controller 202 and an inverter 204, enabling smooth operation across a range of speeds, including near zero speed.

In this embodiment, the motion controller 202 receives input commands and computes reference values for the torque and speed of the motor 208. Specifically, the motion controller 202 generates a torque reference signal 211 and a speed reference 217, where each reference signal may define a target torque that the motor 208 should produce, while the speed reference signal 217 specifies a desired rotor speed. The reference is computed based on the requirement of the application and the load 210 being driven.

The inverter 204, connected to the power supply 206, is responsible for converting DC or AC power 213 into controlled AC voltages 215, which are then applied to the motor 208. The inverter 204 operates according to the reference torque 211 by modulating the output voltage 215 to generate the specified torque in the motor 208. Similarly, if the reference speed 217 is supplied, the inverter 204 adjusts the voltage 215 to drive the motor 208 at the specified speed.

The motor 208 receives these voltages 215, which results in electromagnetic forces that produce a corresponding torque. This torque causes the motor rotor to rotate, driving the load 210 attached to the motor shaft. The load 210 may represent any mechanical system requiring controlled torque or speed, such as an industrial machine, conveyor system, or vehicle drivetrain. The system 200 configuration allows the motion controller 202 to dynamically adjust the torque or speed of the motor 208 based on real time feedback.

FIG. 2B illustrates a schematic of the inverter 204, which serves as a central component in controlling an electric motor by managing the supply of electrical power on reference settings. The inverter 204 comprises a drive controller 252, power electronics 254, and embedded sensor 256, each of which plays a role in achieving precise and dynamic control of motor operation.

The drive controller 252 acts as the core control unit, implemented on a microcontroller. the controller operates based on a programmed control algorithm designed to handle dynamic adjustment in the motor control. Specifically, the driver controller 252 receives sensor signal as feedback on motor 208 operation, as well as control reference 211 and 217 which corresponds to the desired torque or speed of the motor. Based on this information, the drive controller 252 determines the reference 251 for voltage 215 to be applied by the power electronics 254. These voltage references ensure that the motor operates according to the specified torque or speed in real time.

The power electronics 254, commonly referred to as voltage source inverter (VSI), is responsible for converting the voltage reference 251 into actual voltage output 215 that power the motor 208. For a three phase AC motor, the power electronics 254 generate three separate voltage signals, each corresponding to one of the three stator windings, labelled phase A, phase B, phase C. these voltages are phase shifted by a fixed angle of 120 degree relative to one another, as shown in FIG. 2C, which is necessary to create a balanced three phase AC signal. This balanced output facilitates the generation of a rotating magnetic field within the motor, which in turn drives the motor rotor.

The inverter 204 includes the sensor 256 that monitors the three phase currents flowing through each stator winding. These sensors feed real time data back to the drive controller 252, allowing with the reference signal. This feedback loop is critical to maintaining motor stability and achieving the desired performance.

The system operates over a full range of speed and torque levels, including low or zero speed and near zero frequencies, allowing the motor to function effectively even under challenging conditions. This capability is essential for application requiring stable control at very low speed or when the motor 208 is desired to be operated near zero frequency.

FIG. 2C illustrates three frames used for motor control of induction machines. The A-B-C frame is formed by three axes A, B and C, where each axis is 120° degree apart from the other. The A axis is always in alignment with the angle of phase A voltage of the motor. A dq frame, defined by two orthogonal axes d and q axes, rotates at an angular speed of ω₀ which equals the angular speed ωₛ of the rotor flux vector. Particularly, the d-axis of the dq frame always aligns with the rotor flux vector λᵣ. An αβ frame is when ω₀=0, which is also called stationary (or stator) frame. The three frames can be transformed to each other via Clarke/Park Transformations or their inverse, wherein the Clarke/Park transformations and their inverse are uniquely determined by the angle between the dq frame and the ABC frame. Specifically, applying Clarke transformation on the A-B-C frame gives the stationary frame, and applying the Park transformation on the stationary frame gives the dq frame. The Clarke transformation is a mathematical operator employed to transform quantities in a three-phase system, corresponding to A, B, and C axes in FIG. 2C, to a two-phase system, corresponding to α, β axes. Representing quantities in a space vector form significantly simplifies the analysis of three-phase systems. In this disclosure, Clarke transformation is limited to the case which transforms quantities in three-phase such as three-phase stator voltages and currents into a space vector in the stationary frame. Similarly, the Park transformation, or known as d-q transformation, projects the quantities in a stationary frame onto a rotating frame. Clarke/Park transformation and its inverse are well-known for those skilled in the art, and their rigorous description is omitted.

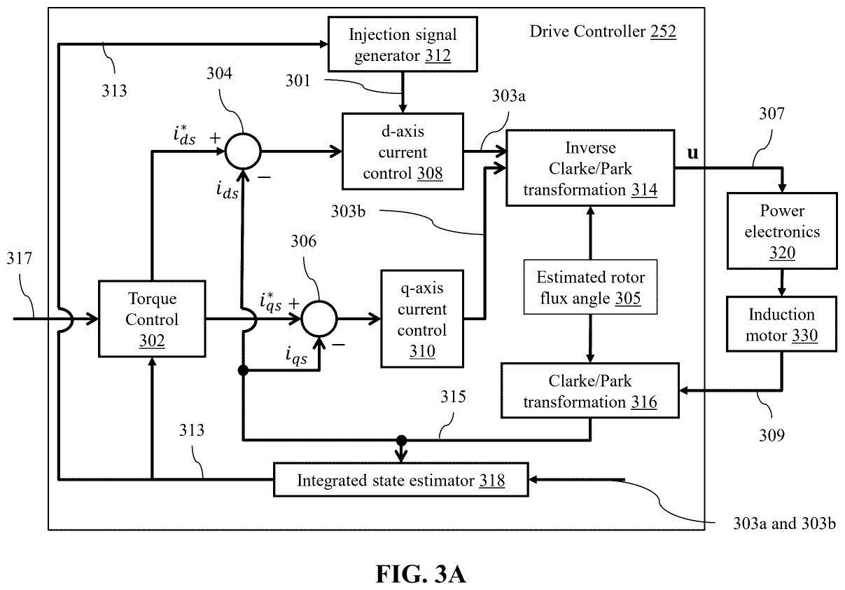

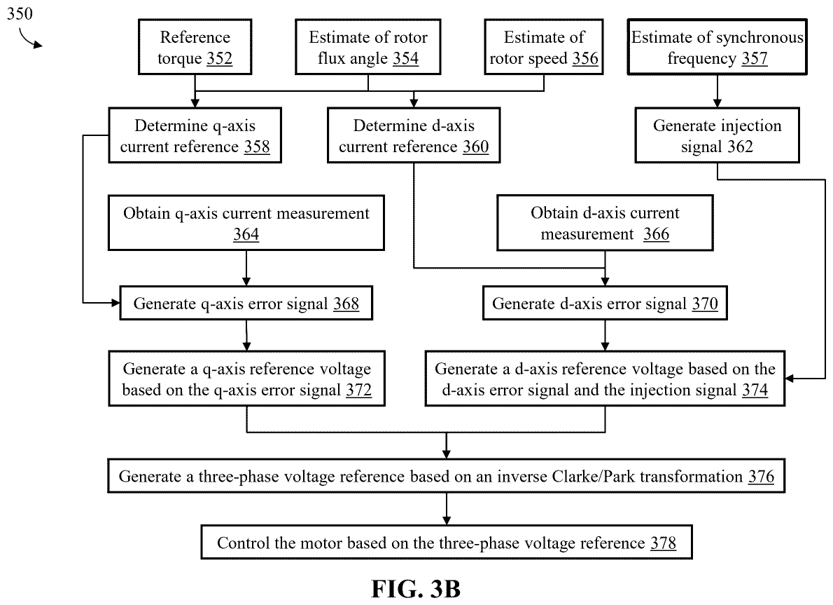

FIG. 3A illustrates schematics of the drive controller 252 for operating an induction machine such as the motor 330 at torque control mode, according to some embodiments. In the torque control mode, the reference 317 of the drive controller 252 is the temporal profile of the preferred torque, denoted as T*. The torque control module 302 determines d-axis current reference

$${i}_{ds}^{*}$$

and q-axis current reference

$${i}_{qs}^{*}$$

according to the estimated rotor flux angle \hat{θ} and rotor speed ωᵣ (collectively shown as 313) from an integrated state estimator 318. An injection signal generator 312 outputs an injection signal 301 based on the estimated synchronous speed \hat{ω}ₛ (part of 313) provided by the integrated state estimator 318. This signal 301 assists in accurately controlling the induction machine, particularly at lower speed or near zero frequency condition.

For precise torque control, the drive controller 252 utilizes the comparator 304 to compare the d-axis current reference

$${i}_{ds}^{*}$$

with the actual d-axis current i_{ds}, measured from the motor 330. The resulting error signal is then supplied to the d-axis current block 308, which generates a d-axis reference voltage u_{qs} 303a based on the injection signal 301, which helps maintain accuracy in torque control.

Similarly, the q-axis current reference

$${i}_{qs}^{*}$$

is compared in the comparator 306 with the measured q-axis current i_{qs}, and the difference is processed by the q-axis current control block 310 to produce the q-axis reference voltage u_{qs} 303b. Together, these d-axis and q-axis reference voltage 303a and 303b respectively define the required voltage inputs for the motor 330 to achieve the desired torque 317.

The controller 252 converts these d-axis and q-axis reference voltages u_{ds} and u_{qs} (i.e., 303a and 303b) into a three-phase voltage reference u=[uₐ, u_{b} u_{c}]^{T} 307 through an inverse Clarke/Park transformation 314 which is uniquely determined by the estimated rotor flux angle 305. The three phase voltage reference 307 is forwarded to the power electronics section 320, which generates the actual three phase voltages to power the induction motor 330.

Since the induction motor 330 operates without direct position or speed sensor, the integrated state estimator 318 is employed to provide real time estimates of the machine interval state. This includes estimates of the fluxes, synchronous speed and rotor speed. The state estimator 318 achieves this by analyzing the motor three phase current measurement 309 and the voltage references 303a and 303b (i.e., u_{ds} and u_{qs}). Specifically, the three-phase current measurement 309 are transferred by a Clarke/Park transformation 316, which is uniquely determined by the estimated rotor flux angle 305, into the d-axis and q-axis current i_{ds} and i_{qs} (collectively denoted as 315), respectively, which are subsequently used by the estimator 318 for further calculation.

FIG. 3B illustrates a flowchart of a method 350 performed by the drive controller 252, according to some embodiments. The reference torque 352, estimate of rotor flux angle 354, the estimate of the rotor speed 356, and the estimate of synchronous frequency 357 are obtained by the drive controller 252. The method 350 comprises determining 358 d-axis current reference and determining 360 q-axis current reference for the induction machine, based on the reference torque 352, the estimate of rotor flux angle 354 and the estimate of rotor speed 356. The method further comprises generating 362 an injection signal based on the estimate of the rotor flux frequency (synchronous frequency) 357, obtaining 364 q-axis current measurement and obtaining 366 d-axis current measurement for the induction machine. The method 350 further comprises generating 370 a d-axis error signal based on the d-axis current reference and the d-axis current measurement and generating 368 a q-axis error signal based on the q-axis current reference and the q-axis current measurement. The method further comprises generating 374 a d-axis reference voltage based on the d-axis error signal and the injection signal and generating 372 a q-axis reference voltage based on the q-axis error signal. The method further comprises generating 376 a three-phase voltage reference from the d-axis reference voltage and q-axis reference voltage into, based on an inverse Clarke/Park transformation. The method further comprises controlling 378 the induction machine based on the three-phase voltage reference.

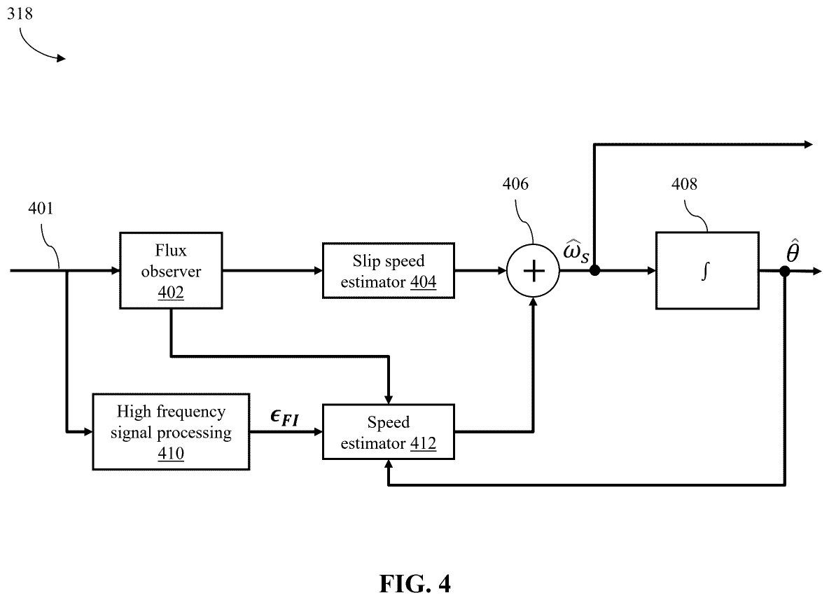

FIG. 4 illustrates a block diagram of the integrated state estimator 318 of the drive controller 300 of FIG. 3A, according to some embodiments. Measured currents and voltage references 401, represented in the estimated dq frame, are submitted to a flux observer 402 and a high-frequency signal processing module 410. The flux observer 402 estimates both stator and rotor fluxes, denoted by x=[λ_{ds}, λ_{qs}, λ_{dr}]^{T}, and outputs the flux estimates x and an estimation error of motor currents, denoted by Ĩₛ=iₛ−Iₛ. Both & and Is are used in a slip speed estimator 404 to reconstruct slip speed. The high frequency signal processing module 410 produces a signal ϵ_{FI} which encodes the error, denoted by \tilde{θ}, between the true rotor flux angle θ and the estimated rotor flux angle \hat{θ}. Both the estimation error of motor currents and the signal ϵ_{FI} are fed into speed estimator 412 which outputs rotor speed estimate. The slip speed estimate and the rotor speed estimate are summed at adder 406 gives the estimated synchronous speed \hat{ω}ₛ, which is integrated over time by the integrator 408 to produce the estimate of the rotor flux angle \hat{θ}.

In some embodiments, the flux observer 402 performs the estimation of stator and rotor flux based on the its model in the dq frame given by:

$$\dot{x} = Ax + {Bu}_{dqs} \qquad ( 26 )$$

$${\dot{ω}}_{r} = \frac{p}{J} ( {T}_{e} - {T}_{l} )$$

$$\dot{θ} = {ω}_{s} ,$$

$$y = Cx$$

$${T}_{e} = {μλ}_{qs} {λ}_{dr}$$

$$μ = \frac{3 p}{2} {L}_{m} ( {c}_{11} {c}_{22} - {c}_{12} {c}_{21} ) ,$$

where

$$A = [ \begin{matrix}{a}_{11} & {ω}_{s} & {a}_{12} \\ - {ω}_{s} & {a}_{11} & 0 \\ {a}_{21} & 0 & {a}_{22}\end{matrix} ] , B = [ \begin{matrix}1 & 0 \\ 0 & 1 \\ 0 & 0\end{matrix} ] , C = [ \begin{matrix}{c}_{11} & 0 & {c}_{12} \\ 0 & {c}_{11} & 0\end{matrix} ] ,$$

$${ω}_{s} = {ω}_{r} + {ω}_{slip} = {ω}_{r} + \frac{{a}_{21} {λ}_{qs}}{{λ}_{dr}} .$$

Based on (26) and the fact that x, ωₛ are unknown, the flux observer 402 estimates all fluxes x according to the following equation:

$$\dot{\hat{x}} = A ( {\hat{ω}}_{s} ) \hat{x} + B + L ( y - \hat{y} ) \qquad ( 27 )$$

$$\hat{y} = C \hat{x} ,$$

where L ∈ [symbol] ^{3×3} is the gain matrix to be appropriately designed. The flux observer 402 is implemented in the estimated dq frame. Given the flux observer output, the slip speed estimator 404 provides the slip speed estimate according to:

$${\hat{ω}}_{slip} = \frac{{a}_{21}}{} .$$

The flux observer 402 relies on the back electromagnetic force (EMF) in the stator winding of the motor. Since the back EMF is close to zero when the motor operates at/near zero frequency/rotor speed, the flux observer 402 does not work well in these operation regions.

In some embodiments, the injection signal generator 312 generates a high-frequency pulsating current

$$= {[ {i}_{h} cos ( {ω}_{h} t ) , 0 ]}^{T} ,$$

which is injected into the d-axis of the estimated dq frame, which, in the true dq frame, can be written as follows

$${i}_{dqs}^{h} = {e}^{- J \tilde{θ}} = {i}_{h} cos ( {ω}_{h} t ) [ \begin{matrix}cos ( \tilde{θ} ) \\ - sin ( \tilde{θ} )\end{matrix} ] , \qquad ( 28 )$$

where iₕ is the magnitude, ωₙ the frequency of the current injection, and

$$J = [ \begin{matrix}0 & - 1 \\ 1 & 0\end{matrix} ] .$$

The frequency ωₕ of the injected signal is typically much higher than that of the synchronous frequency ωₛ which is close to zero at/near zero frequency and at low speed operation regions.

In another embodiment, the injection signal generator 312 generates a high frequency square wave voltage [symbol] into the d-axis of the estimated dq frame.

The true and estimated reference frames (aligned with the true and estimated rotor flux angles, respectively) are indicated by scripts dq, [symbol] , respectively. For a variable 7, its representation in dq, [symbol] frames are denoted by ζ_{dq} and [symbol] respectively. The angle error between the true and estimated frames (or the error between the true rotor flux angle and the estimated rotor flux angle) is denoted \tilde{θ}=θ−\hat{θ}=<λd_{qr}−< [symbol] .

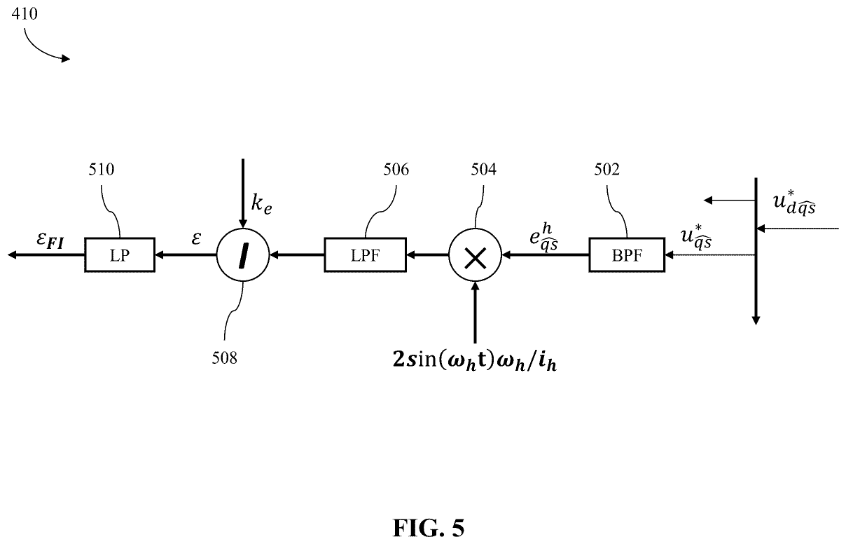

FIG. 5 illustrates a block diagram of the high-frequency signal processing module 410 of the integrated state estimator of FIG. 4. The \hat{q}-axis component of the reference voltage is fed into a band-pass-filter (BPF) 502 to extract the high frequency component of the back-emf in the \hat{q}-axis, denoted by [symbol] The high frequency component of the back-emf in the \hat{q}-axis is then demodulated by multiplying in the multiplier 504, 2 sin (ωₕt) ωₕ/iₕ and further passing through a low-pass-filter (LPF) 506 to yield an error signal ϵ. The error signal ϵ is processed in the divider 508 to produce the signal implying the rotor flux angle error \tilde{θ}, which passes through a lead compensator 510 to yield the signal ϵ_{FI}. The high frequency signal processing complements the flux observer 402 in a way that it produces the signal ϵ_{FI} which effectively encodes the rotor flux angle information at/near zero frequency/rotor speed.

The BPF 502 operates according to the following logic. Given the voltage references denoted as

$$= {[ , ]}^{T} ,$$

the \hat{q}-axis component of the back EMF can be calculated as

$$= - ( {R}_{s} + \frac{{L}_{m}^{2}}{{L}_{r}^{2}} {R}_{r} - σ {L}_{s} s ) ,$$

where s denotes the differential operator. The signal [symbol] is filtered by the BPF 502 (band pass filter) to produce the high frequency component of the back EMF along the \hat{q}-axis. The BPF passes through the frequency components in the proximity to the injected signal frequency ωₕ and filtered lower and higher frequency components. Considering \tilde{θ}«1, sin (\tilde{θ})≈\tilde{θ} and cos (\tilde{θ})≈1, the \hat{q}-axis component of the high-frequency back EMF in the [symbol] frame can be described by the following mathematic formula

$$= \frac{{L}_{m}^{2}}{{L}_{r}^{2}} ( {ω}_{r} {R}_{r} - {k}_{ϵ} \tilde{θ} ) \frac{{i}_{h} sin ( {ω}_{h} t )}{{ω}_{h}} - \frac{3 {p}^{2} {L}_{m}^{3} {R}_{r} {i}_{qs} {λ}_{dr}}{{L}_{r}^{3} 2 J} \frac{{i}_{h} cos ( {ω}_{h} t )}{{ω}_{h}^{2}} , \qquad ( 29 )$$

$$where$$

$${k}_{ϵ} = \frac{3 {p}^{2} {λ}_{dr}^{2}}{2 J} + \frac{{R}_{r}}{{τ}_{r}} .$$

Given (29), the error signal ϵ is obtained by demodulating the high frequency sinusoidal component from [symbol] by the employment of LPF. Given the low pass filter and divide operator 508, the relationship between [symbol] , and the error signal ϵ can be abstracted as the following mathematical formula

$$ϵ = \frac{1}{{k}_{ϵ}} ( {\hat{ω}}_{r} {R}_{r} - \frac{{L}_{r}^{2}}{{L}_{m}^{2}} LPF [ \frac{2 sin ( {ω}_{h} t ) {ω}_{h}}{{i}_{h}} ] ) . \qquad ( 30 )$$

The signal ϵ_{FI} is obtained by feeding e through the lead compensator 510 admitting the following transfer function

$${C}_{lead} ( s ) = \frac{{α}_{c} τ s + 1}{τ s + 1} ,$$

where τ>0 is the time constant and α_{c}>1.

Given flux observer output and ϵ_{FI}, the speed estimator 412 operates according to the following equations:

$${\dot{\hat{ω}}}_{r} = ( {K}_{p} + \frac{{K}_{i}}{s} ) \{ \begin{matrix}{ϵ}_{FI} , & if \vert {\hat{ω}}_{s} \vert < δ \\ \frac{-}{} , & otherwise\end{matrix} \qquad ( 31 )$$

$${\hat{ω}}_{s} = {\hat{ω}}_{r} + \frac{α {L}_{m} {i}_{\hat{q} s}}{{\hat{λ}}_{dr}} .$$

Given the output \hat{ω}ₛ of 406, the integrator 408 outputs the rotor flux angle estimate according to the following formula:

$$\hat{θ} = {\int }_{0}^{t} {\hat{ω}}_{s} dt .$$

The signal injection generator starts spitting out injection signal when |\hat{ω}ₛ|≤δ₁>δ where δ is a user defined threshold. This causes a transition between the two observers—LFSI and baseline.

### Switching Condition

The switching signal S is chosen as the magnitude of the estimated stator frequency, |\hat{ω}ₛ|, which can quantitatively represents the level of observability:

$$S = \vert {\hat{ω}}_{s} \vert . \qquad ( 35 )$$

The pulsating current injection is required for the taught LFI method at S≤δ while it is undesired for baseline adaptive observer at S>δ as it may cause torque ripple and consume extra energy. In order to balance the need for current injection, some embodiments propose to switch the current injection command based on another threshold \tilde{δ}=δ+Δδ, where Δδ>0 is a buffer for current injection settling and can be chosen according to current control bandwidth.

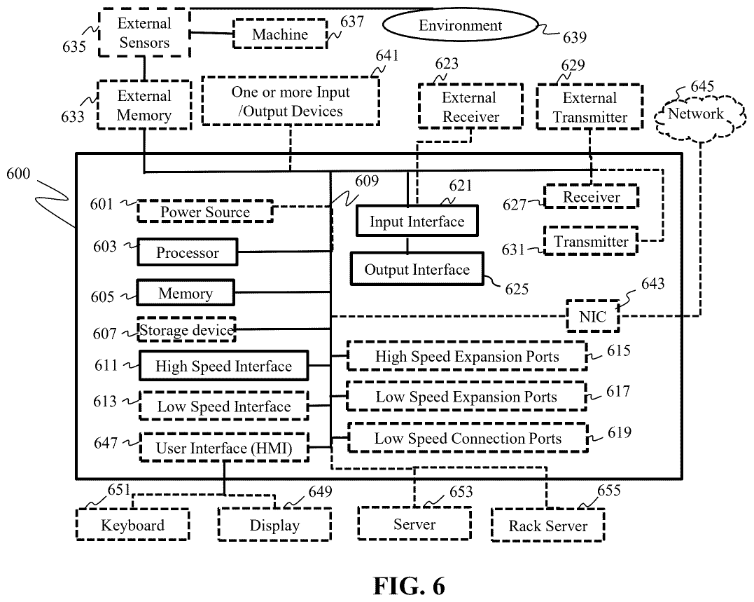

FIG. 6 shows a schematic diagram of some components of a control system 600 for controlling a motor, in accordance with some embodiments of the present disclosure. The control system 600 includes a power source 601, a processor 603, a memory 605, a storage device 607, all connected to a bus 609. Further, a high-speed interface 611, a low-speed interface 613, high-speed expansion ports 615 and low speed connection ports 617, can be connected to the bus 609. In addition, a low-speed expansion port 619 is in connection with the bus 609. Further, an input interface 621 can be connected via the bus 609 to an external receiver 623 and an output interface 625. A receiver 627 can be connected to an external transmitter 629 and a transmitter 631 via the bus 609. Also connected to the bus 609 can be an external memory 633, external sensors 635, machine(s) 637, and an environment 639. Further, one or more external input/output devices 641 can be connected to the bus 609. A network interface controller (NIC) 643 can be adapted to connect through the bus 609 to a network 645, wherein data or other data, among other things, can be rendered on a third-party display device, third party imaging device, and/or third-party printing device outside of the control system 600.

The memory 605 may store instructions that are executable by the control system 600 and any data that can be utilized by the methods and systems of the present disclosure. The memory 605 can include random access memory (RAM), read only memory (ROM), flash memory, or any other suitable memory systems. The memory 605 can be a volatile memory unit or units, and/or a non-volatile memory unit or units. The memory 605 may also be another form of computer-readable medium, such as a magnetic or optical disk.

The storage device 607 can be adapted to store supplementary data and/or software modules used by the control system 600. The storage device 607 can include a hard drive, an optical drive, a thumb-drive, an array of drives, or any combinations thereof. Further, the storage device 607 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 603), perform one or more methods, such as those described above.

The control system 600 can be linked through the bus 609, optionally, to a display interface or user Interface (HMI) 647 adapted to connect the system 600 to a display device 649 and a keyboard 651, wherein the display device 649 can include a computer monitor, camera, television, projector, or mobile device, among others. In some implementations, the system 600 may include a printer interface to connect to a printing device, wherein the printing device can include a liquid inkjet printer, solid ink printer, large-scale commercial printer, thermal printer, UV printer, or dye-sublimation printer, among others.

The high-speed interface 611 manages bandwidth-intensive operations for the control system 600, while the low-speed interface 613 manages lower bandwidth-intensive operations. Such allocation of functions is an example only. In some implementations, the high-speed interface 611 can be coupled to the memory 605, the user interface (HMI) 647, and to the keyboard 651 and the display 649 (e.g., through a graphics processor or accelerator), and to the high-speed expansion ports 615, which may accept various expansion cards via the bus 609. In an implementation, the low-speed interface 613 is coupled to the storage device 607 and the low-speed expansion ports 617, via the bus 609. The low-speed expansion ports 617, which may include various communication ports (e.g., USB, Bluetooth, Ethernet, wireless Ethernet) may be coupled to the one or more input/output devices 641. The control system 600 may be connected to a server 653 and a rack server 655. The control system 600 may be implemented in several different forms. For example, the control system 600 may be implemented as part of the rack server 655.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure Therefore, it is the aspect of the append claims to cover all such variations and modifications as come within the true spirit and scope of the present disclosure.

What is claimed is:

1. A control system for sensorless operation of an induction motor, comprising:
a frequency signal injection (FSI) module configured to inject a pulsating current along a reference axis of the induction motor to generate a first flux estimation error signal at low speeds of the induction motor;
a baseline observer configured to generate a second flux estimation error signal at medium-to-high speeds of the induction motor, based on dynamic equations of the induction motor;
a switching mechanism configured to select between the first flux estimation error signal and the second flux estimation error signal based on a switching signal;
a Proportional-Integral (PI) regulator configured to receive the selected flux estimation error signal to estimate a rotor speed derivative; and
a switching signal generator configured to monitor a stator frequency of the motor and generate the switching signal, wherein the switching signal generator activates the FSI module when the stator frequency falls below a predefined threshold, and wherein the control system provides estimation of rotor flux and rotor speed across a full range of motor speeds by adaptively switching between the FSI and baseline observers based on motor operating conditions.

2. The control system of claim 1, wherein the low speeds and the medium to high speeds of the induction motor are defined relative to a rated operational speed and a rated operational frequency of the induction motor.

3. The control system of claim 1, wherein to generate the first flux estimation error signal, the FSI module is configured to:
generate a high frequency current injection signal along a d-axis of an estimated dq frame;
process a high frequency component of a q-axis reference voltage of the estimated dq frame using a band pass filter to obtain a q-axis high frequency back emf component;
process the q-axis high frequency back emf component with demodulation and a low pass filter to obtain a filtered error signal; and
pass the filtered error signal through a lead compensator to obtain the first flux estimation error signal.

4. The control system of claim 1, wherein the switching signal generator is configured to generate the switching signal based on a value of the stator frequency of the motor.

5. The control system of claim 1, wherein the predefined threshold corresponds to a low frequency operating condition requiring additional observability.

6. The control system of claim 5, wherein the predefined threshold comprises a first value of stator frequency magnitude that corresponds to an operating region of the motor in which the rotor speed is unobservable by the baseline observer.

7. The control system of claim 1, wherein upon activation of the FSI module, the switching signal generator is further configured to obtain a measure of the stator frequency of the motor and delay switching to the second flux estimation error signal till the stator frequency rises above the predefined threshold by a secondary threshold value.

8. The control system of claim 1, wherein the switching signal generator includes a lead compensator to reduce phase delay during transition between the FSI based module and the baseline observer.

9. The control system of claim 6, wherein the baseline observer and the FSI module operate in parallel, to reduce a transient effect during switching between the FSI module and the baseline observer.

10. The control system of claim 1, further comprising an integrator coupled to the PI regulator, wherein the integrator is configured to integrate the rotor speed derivative estimate to obtain a rotor speed estimate for the induction motor.

11. A motor controller, comprising:
a flux observer configured to estimate rotor flux in an induction motor based on a stator voltage and current measurements of the induction motor;
a low-frequency signal injection (LFSI) module configured to inject a pulsating current along a reference axis of the induction motor to generate a first flux estimation error signal at low speeds of the induction motor;
a baseline observer configured to generate a second flux estimation error signal at medium-to-high speeds of the induction motor, based on dynamic equations of the induction motor;
a switching mechanism configured to select between the first flux estimation error signal and the second flux estimation error signal based on a switching signal;
a Proportional-Integral (PI) regulator configured to:
receive the selected flux estimation error signal; and
generate a rotor speed derivative estimate based on the selected flux estimation error signal;
an integrator coupled to the PI regulator, configured to integrate the rotor speed derivative estimate in time to obtain a rotor speed estimate;
a lead compensator coupled to the integrator, configured to adjust phase of the rotor speed estimate to maintain stability during transitions; and
a switching signal generator configured to monitor a stator frequency of the motor and to activate the LFSI module when the stator frequency falls below a predefined threshold,
wherein the control system provides estimation of rotor flux and speed across a full range of motor speeds by adaptively switching between the LFSI and baseline observers based on motor operating conditions.

12. The motor controller of claim 11, wherein the low speeds and the medium to high speeds of the induction motor are defined relative to a rated operational speed of the induction motor and a rated operational frequency of the induction motor.

13. The motor controller of claim 11, wherein the switching signal generator is configured to generate the switching signal based on a value of the stator frequency of the motor.

14. The motor controller of claim 11, wherein the predefined threshold corresponds to a low frequency operating condition requiring additional observability.

15. The motor controller of claim 14, wherein the predefined threshold comprises a first value of stator frequency magnitude that corresponds to an operating region of the induction motor in which the rotor speed is unobservable by the baseline observer.

16. A drive control method for operating an induction machine at torque control mode, the method comprising:
collecting a temporal profile of a preferred torque for the induction machine, a first estimate of rotor flux angle, and a first estimate of rotor speed of the induction machine;
determining d-axis current reference and q-axis current reference for the induction machine, based on the first estimate of rotor flux angle and the first estimate of rotor speed;
generating an injection signal based on the first estimate of rotor speed;
obtaining d-axis current measurement and q-axis current measurement for the induction machine;
generating a d-axis error signal based on the d-axis current reference and the d-axis current measurement;
generating a q-axis error signal based on the q-axis current reference and the q-axis current measurement;
generating a d-axis reference voltage based on the d-axis error signal and the injection signal;
generating a q-axis reference voltage based on the q-axis error signal;
generating a three-phase voltage reference from the d-axis reference voltage and q-axis reference voltage, based on an inverse Clarke/Park transformation; and
controlling the induction machine based on the three-phase voltage reference.
